(19) United States
(12) Patent Application Publication
(10) Pub. No.: US 2013/0141326 A1
(43) Pub. Date: Jun. 6, 2013

(54) GESTURE DETECTING METHOD, GESTURE DETECTING SYSTEM AND COMPUTER READABLE STORAGE MEDIUM

(71) Applicants: Pin-Hong Liou, New Taipei City (TW); Chih-Pin Liao, New Taipei City (TW)

(72) Inventors: Pin-Hong Liou, New Taipei City (TW); Chih-Pin Liao, New Taipei City (TW)

(21) Appl. No.: 13/600,239

(22) Filed: Aug. 31, 2012

(30) Foreign Application Priority Data
Dec. 5, 2011 (TW) 100144731

(51) Int. Cl. G06F 3/033

(52) U.S. Cl. 345/156

(57) ABSTRACT

A gesture detecting method includes steps of defining an initial reference point in a screen of an electronic device; dividing the screen into N areas radially according to the initial reference point; when a gesture corresponding object moves in the screen and a trajectory of the gesture corresponding object crosses M of the N areas, selecting a sample point from each of the M areas so as to obtain M sample points; and calculating a center and a radius of the trajectory of the gesture corresponding object according to P of the M sample points so as to determine a circular or curved trajectory input. Accordingly, the invention is capable of providing a center, a radius, a direction and an arc angle corresponding to a gesture in real-time without establishing a gesture model.

### BACKGROUND OF THE INVENTION

1. Field of the Invention

The invention relates to a gesture detecting method and a gesture detecting system and, more particularly, to a gesture detecting method and a gesture detecting system capable of providing a center, a radius, a direction and an arc angle corresponding to a gesture in real-time without establishing a gesture model.

2. Description of the Prior Art

As motion control gets more and more popular, the present operation behavior of user may change in the future, wherein gesture control may be adapted for various applications. For example, the motion of drawing a circle is instinctive in people, so how to accurately and quickly determine a circular gesture is a significant issue for gesture detecting technology. So far there are some prior arts developed for detecting circular gesture. However, the prior arts have to establish a gesture model in advance and a gesture operated by a user has to be a complete circle. In other words, the prior arts can only detect a circular gesture with the pre-established gesture model. The related circular gesture detecting technology can be referred to U.S. patent publication No. 20100050134 filed by GestureTek, Inc. However, under some applications, the gesture operated by the user has to be determined in real-time before a circle is done. That is to say, if the gesture operated by the user is only an arc instead of a circle, the prior arts cannot recognize the gesture such that the gesture detecting technology is limited.

### SUMMARY OF THE INVENTION

The invention provides a gesture detecting method, a gesture detecting system and a computer readable storage medium to solve the aforesaid problems.

According to an embodiment of the invention, a gesture detecting method comprises steps of defining an initial reference point in a screen of an electronic device; dividing the screen into N areas radially according to the initial reference point, wherein N is a positive integer; when a gesture corresponding object moves in the screen and a trajectory of the gesture corresponding object crosses M of the N areas, selecting a sample point from each of the M areas so as to obtain M sample points, wherein M is a positive integer smaller than or equal to N; and calculating a center and a radius of the trajectory of the gesture corresponding object according to P of the M sample points so as to determine a circular or curved trajectory input, wherein P is a positive integer smaller than or equal to M.

In this embodiment, the gesture detecting method may further comprise steps of assigning a label value for each of the N areas such that each of the M sample points is corresponding to the label value of each of the M areas; calculating a difference between the label value of an i-th sample point and the label value of an (i+1)-th sample point so as to obtain M−1 differences, wherein i is a positive integer smaller than M; accumulating the M−1 differences so as to obtain an accumulated value; and determining a direction of the trajectory of the gesture corresponding object according to positive/negative of the accumulated value.

In this embodiment, the gesture detecting method may further comprise step of calculating an arc angle of the trajectory of the gesture corresponding object by (360/N)*M.

In this embodiment, the gesture detecting method may further comprise step of determining that the trajectory of the gesture corresponding object is a circle when M is equal to N.

According to another embodiment of the invention, a gesture detecting system comprises a data processing device and an input unit, wherein the input unit communicates with the data processing device. The data processing device comprises a processing unit and a display unit electrically connected to the processing unit. The processing unit defines an initial reference point in a screen of the display unit and divides the screen into N areas radially according to the initial reference point, wherein N is a positive integer. The input unit is used for moving a gesture corresponding object in the screen. When a trajectory of the gesture corresponding object crosses M of the N areas, the processing unit selects a sample point from each of the M areas so as to obtain M sample points and calculates a center and a radius of the trajectory of the gesture corresponding object according to P of the M sample points so as to determine a circular or curved trajectory input, wherein M is a positive integer smaller than or equal to N and P is a positive integer smaller than or equal to M.

In this embodiment, the processing unit assigns a label value for each of the N areas such that each of the M sample points is corresponding to the label value of each of the M areas and calculates a difference between the label value of an i-th sample point and the label value of an (i+1)-th sample point so as to obtain M−1 differences, wherein i is a positive integer smaller than M. The data processing device further comprises a counter electrically connected to the processing unit and used for accumulating the M−1 differences so as to obtain an accumulated value. The processing unit determines a direction of the trajectory of the gesture corresponding object according to positive/negative of the accumulated value.

In this embodiment, the processing unit may calculate an arc angle of the trajectory of the gesture corresponding object by (360/N)*M.

In this embodiment, the processing unit may determine that the trajectory of the gesture corresponding object is a circle when M is equal to N.

According to another embodiment of the invention, a computer readable storage medium stores a set of instruction and the set of instructions executes steps of defining an initial reference point in a screen; dividing the screen into N areas radially according to the initial reference point, wherein N is a positive integer; when a gesture corresponding object moves in the screen and a trajectory of the gesture corresponding object crosses M of the N areas, selecting a sample point from each of the M areas so as to obtain M sample points, wherein M is a positive integer smaller than or equal to N; and calculating a center and a radius of the trajectory of the gesture corresponding object according to P of the M sample points so as to determine a circular or curved trajectory input, wherein P is a positive integer smaller than or equal to M.

In this embodiment, the set of instructions may execute steps of assigning a label value for each of the N areas such that each of the M sample points is corresponding to the label value of each of the M areas; calculating a difference between the label value of an i-th sample point and the label value of an (i+1)-th sample point so as to obtain M−1 differences, wherein i is a positive integer smaller than M; accumulating the M−1 differences so as to obtain an accumulated value; and determining a direction of the trajectory of the gesture corresponding object according to positive/negative of the accumulated value.

In this embodiment, the set of instructions may execute step of calculating an arc angle of the trajectory of the gesture corresponding object by (360/N)*M.

In this embodiment, the set of instructions may execute step of determining that the trajectory of the gesture corresponding object is a circle when M is equal to N.

As mentioned in the above, the invention divides the screen of the electronic device into a plurality of areas radially and determines the center, radius, direction and arc angle corresponding to the trajectory of the gesture corresponding object according to how many areas the trajectory of the gesture corresponding object crosses in the screen. When the trajectory of the gesture corresponding object crosses all areas in the screen, the invention determines the trajectory of the gesture corresponding object is a circular gesture accordingly. Therefore, the invention is capable of providing a center, a radius, a direction and an arc angle corresponding to a gesture in real-time without establishing a gesture model so as to provide various gesture definitions and applications thereof.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating three types of gesture detecting systems according to an embodiment of the invention.

FIG. 2 is a functional block diagram illustrating the gesture detecting system shown in FIG. 1.

FIG. 3 is a flowchart illustrating a gesture detecting method according to an embodiment of the invention.

FIG. 4 is a schematic diagram illustrating a screen of the display unit being divided into a plurality of areas radially.

FIG. 5 is a schematic diagram illustrating a trajectory of the gesture corresponding object being performed in the screen shown in FIG. 4.

FIG. 6 is a schematic diagram illustrating an initial reference point shown in FIG. 5 being replaced and updated by a center of the trajectory of the gesture corresponding object and the screen being redivided into a plurality of areas radially according to the center.

FIG. 7 is a schematic diagram illustrating the trajectory of the gesture corresponding object being used to zoom in/out an image.

FIG. 8 is a schematic diagram illustrating another trajectory of the gesture corresponding object being performed in the screen shown in FIG. 4.

### DETAILED DESCRIPTION

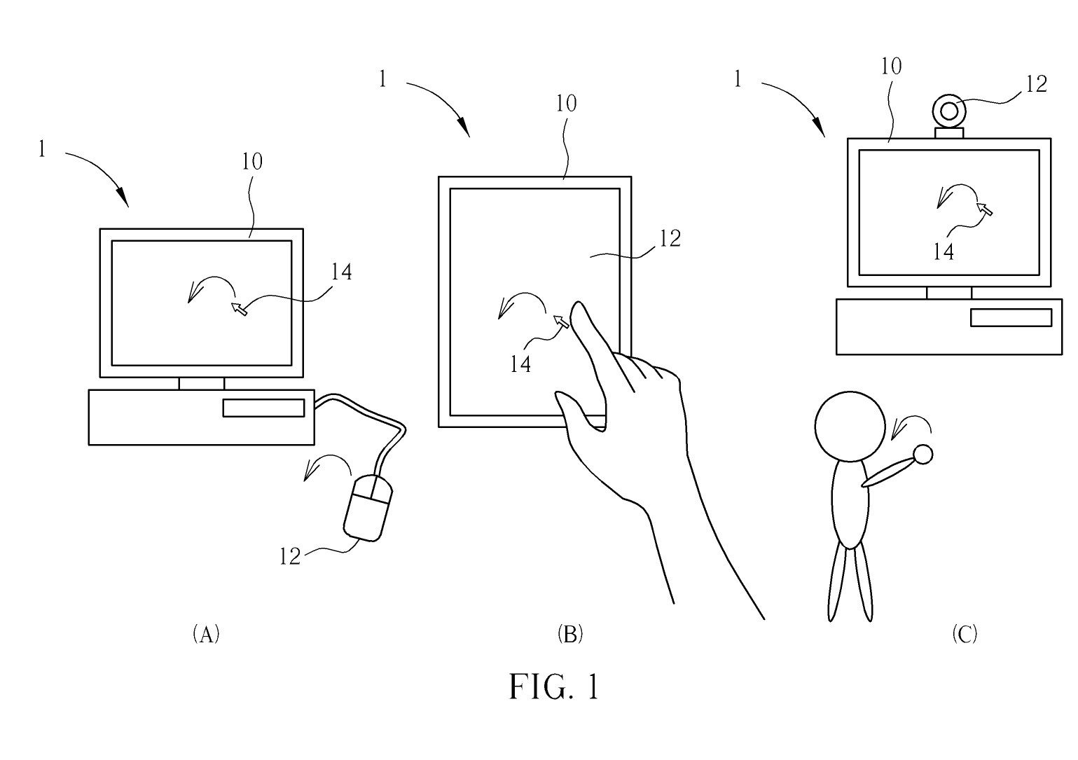

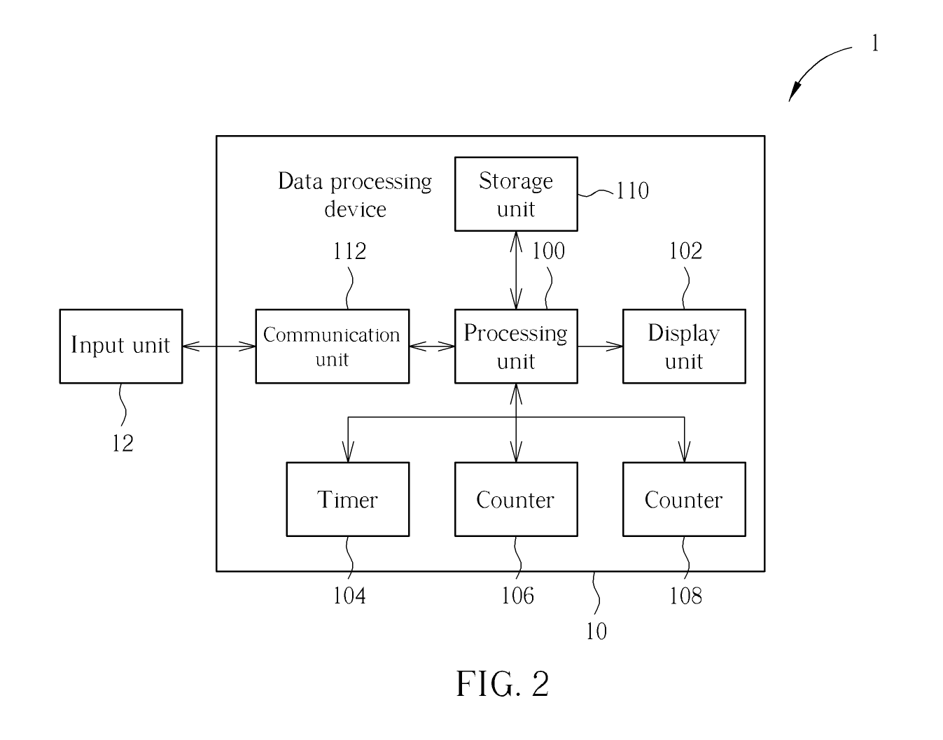

Referring to FIGS. 1 and 2, FIG. 1 is a schematic diagram illustrating three types of gesture detecting systems 1 according to an embodiment of the invention, and FIG. 2 is a functional block diagram illustrating the gesture detecting system 1 shown in FIG. 1. As shown in FIG. 1, each of the three gesture detecting systems 1 comprises a data processing device 10 and an input unit 12. As shown in FIG. 1(A), the data processing device 10 may be a computer, the input unit 12 may be a mouse, and a user may operate the mouse to perform a gesture so as to control a gesture corresponding object, such as a cursor 14 or other user interfaces, to execute corresponding function. As shown in FIG. 1(B), the data processing device 10 may be a flat computer, the input unit 12 may be a touch panel, and a user may perform a gesture on the touch panel so as to control a gesture corresponding object, such as a cursor 14 or other user interfaces, to execute corresponding function. As shown in FIG. 1(C), the data processing device 10 may be a computer, the input unit 12 may be a camera, and a user may perform a gesture in front of the camera and the computer processes an image captured by the camera through image recognition technology so as to control a gesture corresponding object, such as a cursor 14 or other user interfaces, to execute corresponding function. It should be noted that the data processing device 10 of the invention may be any electronic devices with data processing function, such as personal computer, notebook, flat computer, personal digital assistant, smart TV, smart phone, etc.

As shown in FIG. 2, the data processing device 10 comprises a processing unit 100, a display unit 102, a timer 104, two counters 106, 108, a storage unit 110 and a communication unit 112, wherein the display unit 102, the timer 104, the counters 106, 108, the storage unit 110 and the communication unit 112 are electrically connected to the processing unit 100. The input unit 12 may communicate with the data processing device 10 through the communication unit 112 in wired or wireless manner, wherein wired or wireless communication may be achieved by one skilled in the art easily and the related description will not be depicted herein. In practical applications, the processing unit 100 may be a processor or controller with data processing function, the display unit 102 may be a liquid crystal display device or other display devices, and the storage unit 110 may be a combination of a plurality of registers or other storage devices capable of storing data. In this embodiment, the input unit 12 is used for operating the gesture corresponding object, such as the cursor 14 or other user interfaces, to perform a gesture in the screen of the display unit 102 so as to execute corresponding function.

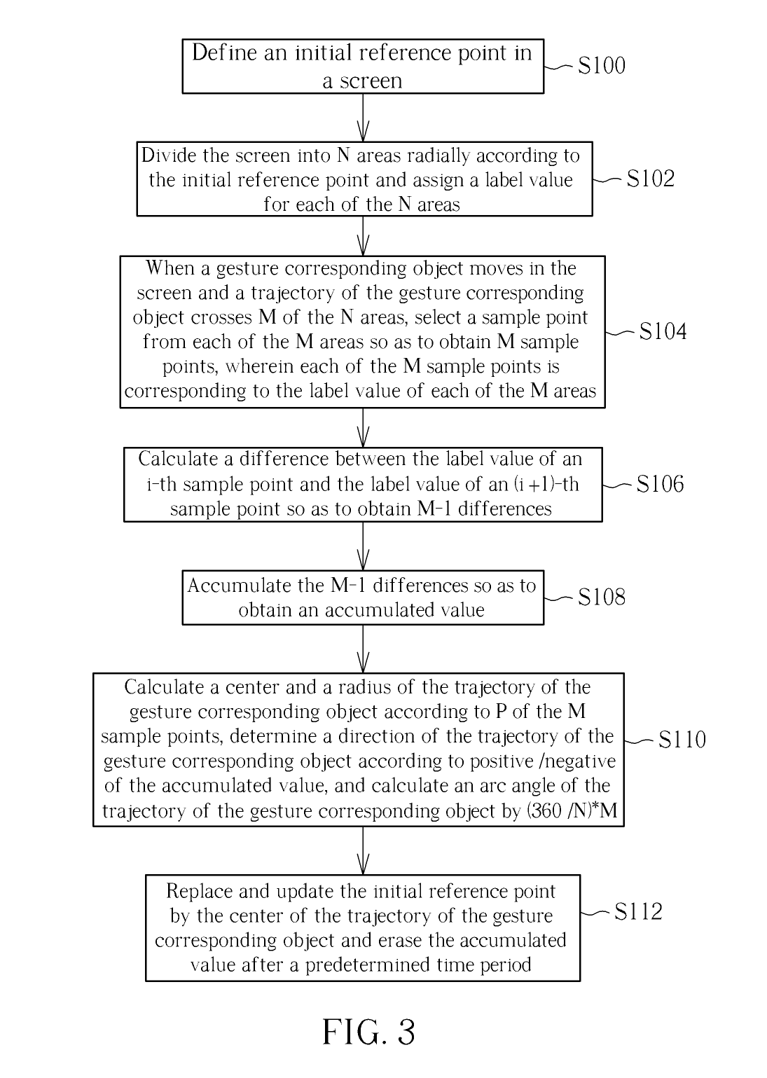

Referring to FIG. 3, FIG. 3 is a flowchart illustrating a gesture detecting method according to an embodiment of the invention. As shown in FIG. 3, first of all, step S100 is performed to define an initial reference point in a screen of a data processing device 10 or an electronic device. Afterward, step S102 is performed to divide the screen into N areas radially according to the initial reference point and assign a label value for each of the N areas, wherein N is a positive integer. When a gesture corresponding object (e.g. a cursor) moves in the screen and a trajectory of the gesture corresponding object crosses M of the N areas, Step S104 is then performed to select a sample point from each of the M areas so as to obtain M sample points, wherein each of the M sample points is corresponding to the label value of each of the M areas and M is a positive integer smaller than or equal to N. Step S106 is then performed to calculate a difference between the label value of an i-th sample point and the label value of an (i+1)-th sample point so as to obtain M−1 differences, wherein i is a positive integer smaller than M. Step S108 is then performed to accumulate the M−1 differences so as to obtain an accumulated value. Step S110 is then performed to calculate a center and a radius of the trajectory of the gesture corresponding object according to P of the M sample points, determine a direction of the trajectory of the gesture corresponding object according to positive/negative of the accumulated value, and calculate an arc angle of the trajectory of the gesture corresponding object by (360/N)*M, wherein P is a positive integer smaller than or equal to M. Step S112 is then performed to replace and update the initial reference point by the center of the trajectory of the gesture corresponding object and erase the accumulated value after a predetermined time period. When M is equal to N, the gesture detecting method of the invention will determine that the gesture performed by the user is a circle. Furthermore, in step S110, the gesture detecting method of the invention may calculate the center and the radius of the trajectory of the gesture corresponding object by least square method according to coordinates of the P sample points.

In the following, an embodiment is depicted along with the gesture detecting system 1 shown in FIG. 2 and the gesture detecting method shown in FIG. 3 so as to show features of the invention.

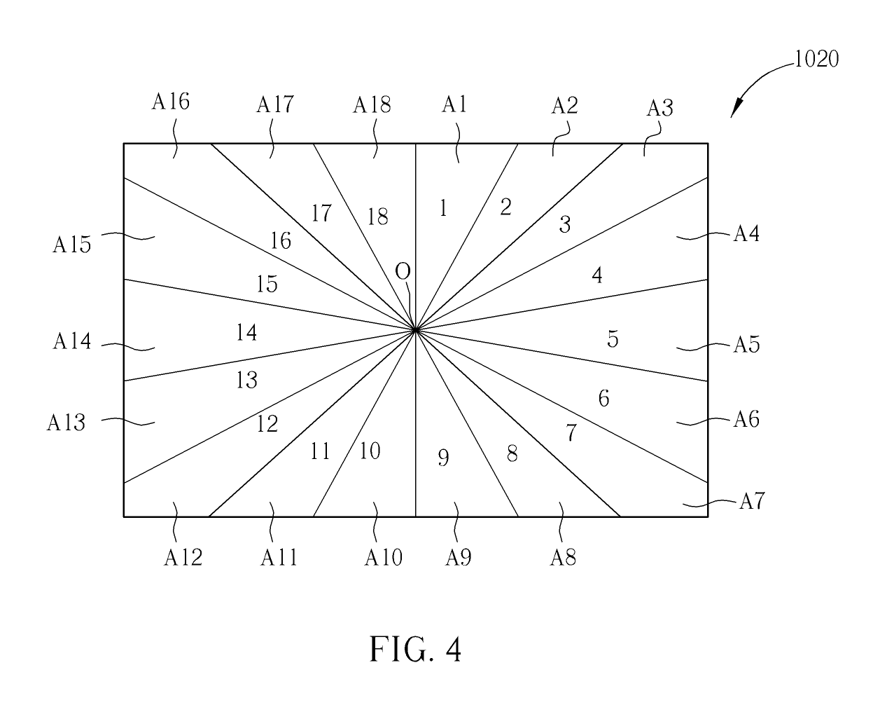

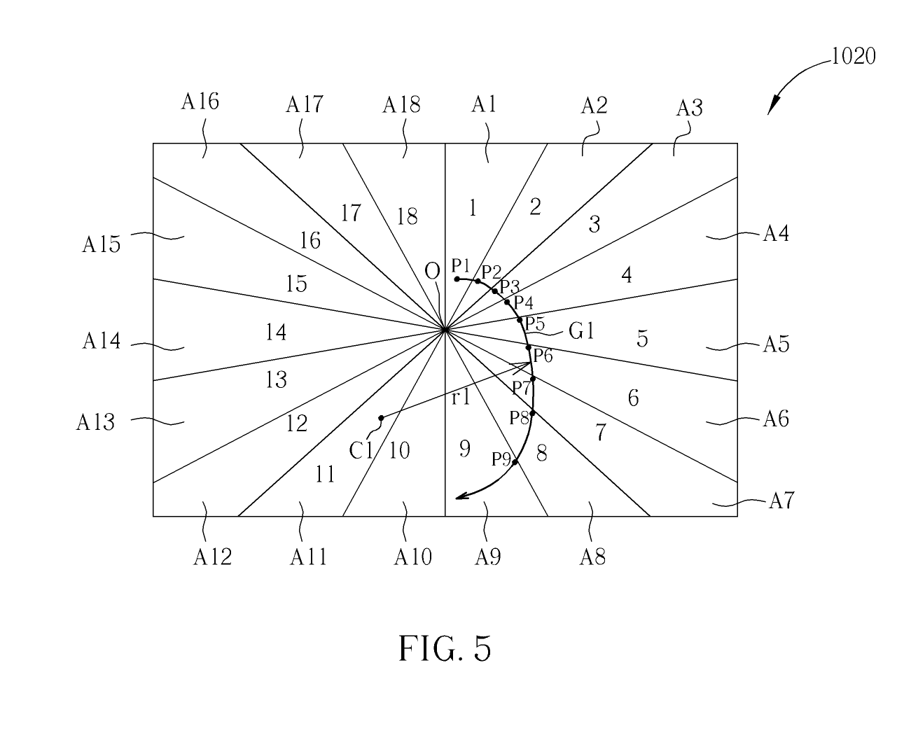

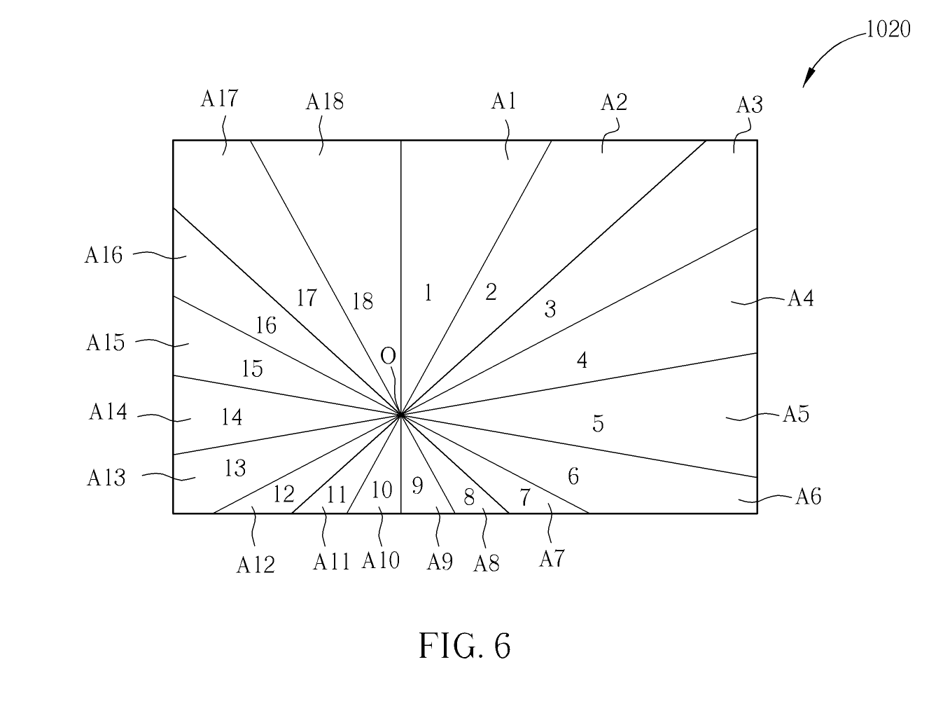

Referring to FIGS. 4 to 6, FIG. 4 is a schematic diagram illustrating a screen 1020 of the display unit 102 being divided into a plurality of areas radially, FIG. 5 is a schematic diagram illustrating a trajectory G1 of the gesture corresponding object being performed in the screen 1020 shown in FIG. 4, and FIG. 6 is a schematic diagram illustrating an initial reference point O shown in FIG. 5 being replaced and updated by a center C1 of the trajectory G1 of the gesture corresponding object and the screen 1020 being redivided into a plurality of areas radially according to the center C1. When a user uses the gesture detecting system 1 of the invention to detect a gesture, first of all, the processing unit 100 defines an initial reference point O in a screen 1020 of the display unit 102 (step S100). Afterward, as shown in FIG. 4, the processing unit 100 divides the screen 1020 into eighteen areas A1-A18 radially (i.e. the aforesaid N is equal to eighteen) according to the initial reference point O and assigns label values 1-18 for the eighteen areas A1-A18 respectively (step S102). In other words, N is equal to, but not limited to, eighteen in this embodiment. It should be noted that the larger the value of N is, the more accurate the gesture detecting result is.

As shown in FIG. 5, when a trajectory G1 of a gesture corresponding object is performed in the screen 1020 and crosses nine areas A1-A9 of the eighteen areas A1-A18 (i.e. the aforesaid M is equal to nine), the processing unit 100 selects a sample point from each of the nine areas A1-A9 so as to obtain nine sample points P1-P9, wherein the nine sample points P1-P9 are corresponding to the label values 1-9 of the nine areas A1-A9 respectively (step S104). Afterward, the processing unit 100 calculates a difference between two label values of two adjacent sample points so as to obtain eight differences (step S106) and accumulates the eight differences in the counter 106 so as to obtain an accumulated value (step S108). For example, the difference between the label value 1 of the first sample point P1 and the label value 2 of the second sample point P2 is equal to one (i.e. 2−1=1), the difference between the label value 2 of the second sample point P2 and the label value 3 of the third sample point P3 is equal to one (i.e. 3−2=1), and so on. Accordingly, the accumulated value accumulated in the counter 106 is equal to eight.

It should be noted that when selecting the aforesaid sample points P1-P9, the processing unit 100 may select a plurality of points on the trajectory G1 of the gesture corresponding object and then calculate a difference between the label values of former and later points. If the difference is equal to zero, it means that the two points are located at the same area, so the later point will not be sampled. If the difference is unequal to zero, it means that the two points are located at different areas, so the later point will be sampled. The aforesaid sampling manner is to ensure the distance between two sample points should be far enough (e.g. located at different areas) so as to prevent the processing unit 100 from calculating irrational center of the trajectory due to concentrated sample points.

In this embodiment, the processing unit 100 may calculate a center and a radius of the trajectory G1 of the gesture corresponding object by least square method according to coordinates of per nine sample points (i.e. the aforesaid P is equal to nine). It should be noted that the invention may use nine registers to store nine sample points, which are used to calculate the center and the radius of the trajectory G1 of the gesture corresponding object, respectively. When the counter 108 accumulates that the processing unit 100 has selected nine sample points P1-P9 on the trajectory G1 of the gesture corresponding object, the processing unit 100 will calculate the center C1 and the radius r1 of the trajectory G1 of the gesture corresponding object by least square method according to coordinates of the nine sample points P1-P9 (step S110). Furthermore, the processing unit 100 may determine a direction of the trajectory G1 of the gesture corresponding object according to positive/negative of an accumulated value accumulated in the counter 106. In this embodiment, the accumulated value accumulated in the counter 106 is equal to eight (i.e. positive), so the processing unit 100 determines that the direction of the trajectory G1 of the gesture corresponding object is clockwise (step S110), as shown in FIG. 5. Moreover, the processing unit 100 may calculate an arc angle of the trajectory G1 of the gesture corresponding object by (360/N)*M. In this embodiment, N is equal to eighteen and M is equal to nine. Accordingly, the arc angle of the trajectory G1 of the gesture corresponding object calculated by the processing unit 100 is equal to 180 degrees (step S110) and the processing unit 100 may determine that the trajectory G1 of the gesture corresponding object is a half circle according to the arc angle. It should be noted that the invention may use four registers to store the center, the radius, the direction and the arc angle of the trajectory G1 of the gesture corresponding object respectively.

Afterward, the processing unit 100 will replace and update the initial reference point O by the center C1 of the trajectory G1 of the gesture corresponding object and erase the accumulated value in the counter 106 after a predetermined time period (e.g. three seconds) accumulated in the timer 104. As shown in FIG. 6, the processing unit 100 redivides the screen 1020 into eighteen areas A1-A18 radially according to the center C1 of the trajectory G1 of the gesture corresponding object and assigns label values 1-18 for the eighteen areas A1-A18 respectively (step S112). Then, the user may operate the input unit 12 to perform another trajectory by moving the gesture corresponding object in the screen 1020 and the data processing device 10 will re-execute the aforesaid steps S100-S112 so as to determine a center, a radius, a direction and an arc angle of another trajectory of the gesture corresponding object.

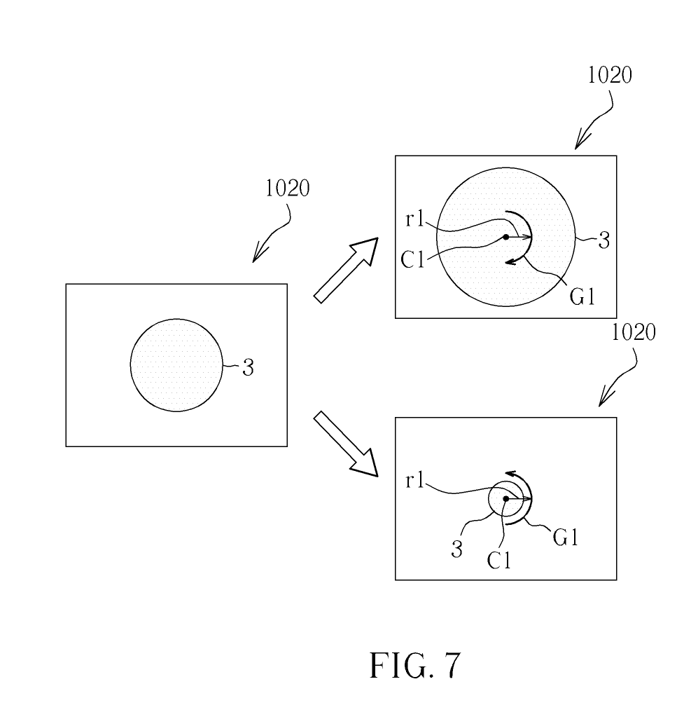

In this embodiment, the data processing device 10 may use at least one of the center C1, the radius r1, the direction and the arc angle of the trajectory G1 of the gesture corresponding object to execute corresponding function. Referring to FIG. 7, FIG. 7 is a schematic diagram illustrating the trajectory G1 of the gesture corresponding object being used to zoom in/out an image 3. As shown in FIG. 7, if a user performs a gesture to locate the center C1 of the trajectory G1 of the gesture corresponding object on an image 3, it means that the user wants to zoom in/out the image 3 by the gesture. The value of the radius r1 of the trajectory G1 of the gesture corresponding object may be used to control speed of zooming in/out the image 3. For example, the larger the radius r1 is (i.e. the larger the gesture of drawing a circle is), the faster the speed of zooming in/out the image 3 is; the smaller the radius r1 is (i.e. the smaller the gesture of drawing a circle is), the slower the speed of zooming in/out the image 3 is. The direction of the trajectory G1 of the gesture corresponding object maybe used to determine whether to zoom in/out the image 3. For example, the image 3 will be zoomed in if the direction is clockwise and the image 3 will be zoomed out if the direction is counterclockwise. The arc angle of the trajectory G1 of the gesture corresponding object may be used to determine a ratio of zooming in/out the image 3.

It should be noted that the aforesaid zoom in/out function is only one embodiment for illustration purpose. The invention is not limited to the aforesaid embodiment and may be adapted to other applications based on practical design.

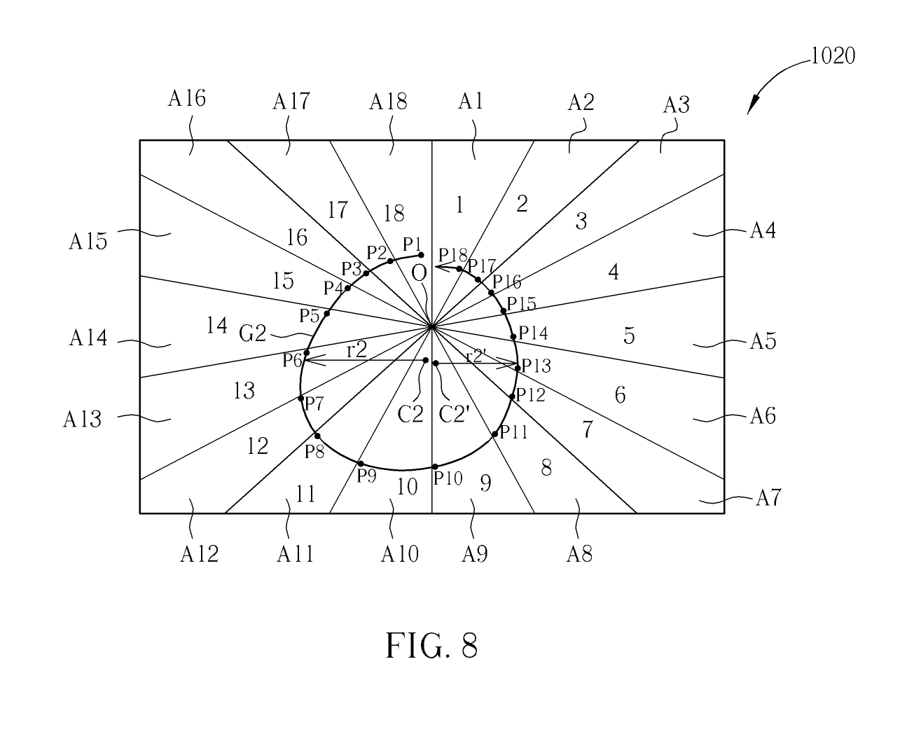

Referring to FIG. 8, FIG. 8 is a schematic diagram illustrating another trajectory G2 of the gesture corresponding object being performed in the screen 1020 shown in FIG. 4. As shown in FIG. 8, when another trajectory G2 of the gesture corresponding object is performed in the screen 1020 and crosses eighteen areas A1-A18 of the eighteen areas A1-A18 (i.e. the aforesaid M is equal to eighteen), the processing unit 100 selects a sample point from each of the eighteen areas A1-A18 so as to obtain eighteen sample points P1-P18, wherein the eighteen sample points P1-P18 are corresponding to the label values 18-1 of the eighteen areas A18-A1 respectively (step S104). Afterward, the processing unit 100 calculates a difference between two label values of two adjacent sample points so as to obtain seventeen differences (step S106) and accumulates the seventeen differences in the counter 106 so as to obtain an accumulated value (step S108). For example, the difference between the label value 18 of the first sample point P1 and the label value 17 of the second sample point P2 is equal to minus one (i.e. 17−18=−1), the difference between the label value 17 of the second sample point P2 and the label value 16 of the third sample point P3 is equal to minus one (i.e. 16−17=−1), and so on. Accordingly, the accumulated value accumulated in the counter 106 is equal to minus seventeen.

In this embodiment, the processing unit 100 may calculate a center and a radius of the trajectory G2 of the gesture corresponding object by least square method according to coordinates of per nine sample points (i.e. the aforesaid P is equal to nine). It should be noted that the invention may use nine registers to store nine sample points, which are used to calculate the center and the radius of the trajectory G2 of the gesture corresponding object, respectively. When the counter 108 accumulates that the processing unit 100 has selected nine sample points P1-P9 on the trajectory G2 of the gesture corresponding object, the processing unit 100 will calculate the center C2 and the radius r2 of the trajectory G2 of the gesture corresponding object by least square method according to coordinates of the nine sample points P1-P9 (step S110). Afterward, the processing unit 100 will replace and update the initial reference point O by the center C2 of the trajectory G2 of the gesture corresponding object and erase the accumulated value in the counter 108. Then, when the counter 108 accumulates that the processing unit 100 has selected another nine sample points P10-P18 on the trajectory G2 of the gesture corresponding object, the processing unit 100 will calculate the center C2′ and the radius r2′ of the trajectory G2 of the gesture corresponding object by least square method according to coordinates of the nine sample points P10-P18 (step S110). Afterward, the processing unit 100 will replace and update the center C2 by the center C2′ of the trajectory G2 of the gesture corresponding object and update the radius r2 by the radius r2′. In other words, the invention will replace and update the center and the radius continuously while the trajectory of the gesture corresponding object is moving. It should be noted that the number of sample points, which is used for replacing and updating the center and the radius, can be determined based on practical applications and is not limited to the aforesaid nine sample points.

In this embodiment, the accumulated value accumulated in the counter 106 is equal to minus seventeen (i.e. negative), so the processing unit 100 determines that the direction of the trajectory G2 of the gesture corresponding object is counterclockwise (step S110), as shown in FIG. 8. Moreover, the processing unit 100 may calculate an arc angle of the trajectory G2 of the gesture corresponding object by (360/N)*M. In this embodiment, N is equal to eighteen and M is also equal to eighteen. Accordingly, the arc angle of the trajectory G2 of the gesture corresponding object calculated by the processing unit 100 is equal to 360 degrees (step S110) and the processing unit 100 may determine that the trajectory G2 of the gesture corresponding object is a circle according to the arc angle.

Furthermore, the control logic of the gesture detecting method shown in FIG. 3 can be implemented by software. The software can be executed in any data processing devices 10 with data processing function, such as personal computer, notebook, flat computer, personal digital assistant, smart TV, smart phone, etc. Still further, each part or function of the control logic maybe implemented by software, hardware or the combination thereof. Moreover, the control logic of the gesture detecting method shown in FIG. 3 can be embodied by a computer readable storage medium, wherein the computer readable storage medium stores instructions, which can be executed by an electronic device so as to generate control command for controlling the data processing device 10 to execute corresponding function.

Compared with the prior art, the invention divides the screen into a plurality of areas and determines the center, radius, direction and arc angle corresponding to the trajectory of the gesture corresponding object according to how many areas the trajectory of the gesture corresponding object crosses in the screen. When the trajectory of the gesture corresponding object crosses all areas in the screen, the invention determines the trajectory of the gesture corresponding object is a circular gesture accordingly. Therefore, the invention is capable of providing a center, a radius, a direction and an arc angle corresponding to a gesture in real-time without establishing a gesture model so as to provide various gesture definitions and applications thereof.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A gesture detecting method comprising:
defining an initial reference point in a screen of an electronic device;
dividing the screen into N areas radially according to the initial reference point, wherein N is a positive integer;
when a gesture corresponding object moves in the screen and a trajectory of the gesture corresponding object crosses M of the N areas, selecting a sample point from each of the M areas so as to obtain M sample points, wherein M is a positive integer smaller than or equal to N; and
calculating a center and a radius of the trajectory of the gesture corresponding object according to P of the M sample points so as to determine a circular or curved trajectory input, wherein P is a positive integer smaller than or equal to M.

2. The gesture detecting method of claim 1 further comprising:
assigning a label value for each of the N areas such that each of the M sample points is corresponding to the label value of each of the M areas;
calculating a difference between the label value of an i-th sample point and the label value of an (i+1)-th sample point so as to obtain M−1 differences, wherein i is a positive integer smaller than M;
accumulating the M−1 differences so as to obtain an accumulated value; and
determining a direction of the trajectory of the gesture corresponding object according to positive/negative of the accumulated value.

3. The gesture detecting method of claim 2 further comprising:
erasing the accumulated value after a predetermined time period.

4. The gesture detecting method of claim 2 further comprising:
if the accumulated value is positive, determining that the direction of the trajectory of the gesture corresponding object is clockwise; and
if the accumulated value is negative, determining that the direction of the trajectory of the gesture corresponding object is counterclockwise.

5. The gesture detecting method of claim 1 further comprising:
calculating an arc angle of the trajectory of the gesture corresponding object by (360/N)*M.

6. The gesture detecting method of claim 1 further comprising:
determining that the trajectory of the gesture corresponding object is a circle when M is equal to N.

7. The gesture detecting method of claim 1 further comprising:
calculating the center and the radius by least square method according to coordinates of the P sample points.

8. The gesture detecting method of claim 1 further comprising:
replacing and updating the initial reference point by the center.

9. A gesture detecting system comprising:
a data processing device comprising a processing unit and a display unit electrically connected to the processing unit, the processing unit defining an initial reference point in a screen of the display unit and dividing the screen into N areas radially according to the initial reference point, wherein N is a positive integer; and
an input unit communicating with the data processing device, the input unit being used for moving a gesture corresponding object in the screen;
wherein when a trajectory of the gesture corresponding object crosses M of the N areas, the processing unit selects a sample point from each of the M areas so as to obtain M sample points and calculates a center and a radius of the trajectory of the gesture corresponding object according to P of the M sample points so as to determine a circular or curved trajectory input, wherein M is a positive integer smaller than or equal to N and P is a positive integer smaller than or equal to M.

10. The gesture detecting system of claim 9, wherein the processing unit assigns a label value for each of the N areas such that each of the M sample points is corresponding to the label value of each of the M areas and calculates a difference between the label value of an i-th sample point and the label value of an (i+1)-th sample point so as to obtain M−1 differences, wherein i is a positive integer smaller than M, the data processing device further comprises a counter electrically connected to the processing unit and used for accumulating the M−1 differences so as to obtain an accumulated value, the processing unit determines a direction of the trajectory of the gesture corresponding object according to positive/negative of the accumulated value.

11. The gesture detecting system of claim 10, wherein the processing unit determines that the direction of the trajectory of the gesture corresponding object is clockwise if the accumulated value is positive and determines that the direction of the trajectory of the gesture corresponding object is counterclockwise if the accumulated value is negative.

12. The gesture detecting system of claim 10, wherein the data processing device further comprising a timer electrically connected to the processing unit and used for accumulating a predetermined time period, the processing unit erases the accumulated value in the counter after the predetermined time period.

13. The gesture detecting system of claim 9, wherein the processing unit calculates an arc angle of the trajectory of the gesture corresponding object by (360/N)*M.

14. The gesture detecting system of claim 9, wherein when M is equal to N, the processing unit determines that the trajectory of the gesture corresponding object is a circle.

15. The gesture detecting system of claim 9, wherein the processing unit calculates the center and the radius by least square method according to coordinates of the P sample points.

16. The gesture detecting system of claim 9, wherein the processing unit replaces and updates the initial reference point by the center.

17. A computer readable storage medium for storing a set of instructions, the set of instructions executing steps of:
defining an initial reference point in a screen;
dividing the screen into N areas radially according to the initial reference point, wherein N is a positive integer;
when a gesture corresponding object moves in the screen and a trajectory of the gesture corresponding object crosses M of the N areas, selecting a sample point from each of the M areas so as to obtain M sample points, wherein M is a positive integer smaller than or equal to N; and
calculating a center and a radius of the trajectory of the gesture corresponding object according to P of the M sample points so as to determine a circular or curved trajectory input, wherein P is a positive integer smaller than or equal to M.

18. The computer readable storage medium of claim 17, the set of instructions executing steps of:
assigning a label value for each of the N areas such that each of the M sample points is corresponding to the label value of each of the M areas;
calculating a difference between the label value of an i-th sample point and the label value of an (i+1)-th sample point so as to obtain M−1 differences, wherein i is a positive integer smaller than M;
accumulating the M−1 differences so as to obtain an accumulated value; and
determining a direction of the trajectory of the gesture corresponding object according to positive/negative of the accumulated value.

19. The computer readable storage medium of claim 18, the set of instructions executing steps of:
if the accumulated value is positive, determining that the direction of the trajectory of the gesture corresponding object is clockwise; and
if the accumulated value is negative, determining that the direction of the trajectory of the gesture corresponding object is counterclockwise.

20. The computer readable storage medium of claim 18, the set of instructions executing steps of:
erasing the accumulated value after a predetermined time period.

21. The computer readable storage medium of claim 17, the set of instructions executing steps of:
calculating an arc angle of the trajectory of the gesture corresponding object by (360/N)*M.

22. The computer readable storage medium of claim 17, the set of instructions executing steps of:
determining that the trajectory of the gesture corresponding object is a circle when M is equal to N.

23. The computer readable storage medium of claim 17, the set of instructions executing steps of:
calculating the center and the radius by least square method according to the coordinates of the P sample points.

24. The computer readable storage medium of claim 17, the set of instructions executing steps of:
replacing and updating the initial reference point by the center.
